(19) United States
(12) Patent Application Publication
(10) Pub. No.: US 2001/0037319 A1
(43) Pub. Date: Nov. 1, 2001

(54) Public submission content library

(76) Inventors: Eric Edwards, San Francisco, CA (US); Clay Harvey Fisher, Belmont, CA (US); Kurt Jonach, San Jose, CA (US); Neal Jacob Manowitz, Mahwah, NJ (US); Kengo Masu, San Diego, CA (US); Robert Jay Sato, Sausalito, CA (US); John Tree, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/771,398

(22) Filed: Jan. 25, 2001

Related U.S. Application Data
(60) Provisional application No. 60/181,786, filed on Feb. 11, 2000.
(60) Provisional application No. 60/181,845, filed on Feb. 11, 2000.

(51) Int. Cl. G06F 17/60

(52) U.S. Cl. 705/80; 705/37; 705/51; 705/54; 705/57; 705/59

(57) ABSTRACT

A content brokering system for a public submission content library facilitates the exchange digital content between a buyer and a seller. The content brokering system provides a searching function that allows a buyer to find content stored on the brokering system, or a seller to find a request for content posted on the brokering system by a buyer. The content brokering system also assists the negotiations between a buyer and seller through a financial function. The financial function further may handle all the financial arrangements for the sale or lease of the content between the parties.

### RELATED APPLICATIONS

This application claims the benefit of U.S. Provisional Application Nos. 60/181,786 and 60/181,845 filed on Feb. 11, 2000.

### FIELD OF THE INVENTION

This invention relates generally to digital content storage, and more particularly to an on-line library of digital content.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2000, Sony Electronics, Inc., All Rights Reserved.

### BACKGROUND OF THE INVENTION

Digital content, such as images, video, music, text, games and applications, is widely available for purchase on the Internet and World Wide Web. However, such content is predominately owned by organizations and businesses. Ordinary consumers find it difficult to manage the financial transactions necessary to offer their content for sale to the public. Furthermore, the content that is posted may not satisfy the particular needs of an consumer but currently there are few ways in which an individual can find who has non-posted content that does meet his/her needs.

### SUMMARY OF THE INVENTION

A content brokering system for a public submission content library facilitates the exchange digital content between a buyer and a seller. The content brokering system provides a searching function that allows a buyer to find content stored on the brokering system, or a seller to find a request for content posted on the brokering system by a buyer. The content brokering system also assists the negotiations between a buyer and seller through a financial function. The financial function further may handle all the financial arrangements for the sale or lease of the content between the parties. In other aspects, the content brokering system provides a watermarking function to mark the content for limited use, a ratings function that rates the buyer, seller and/or content, and a tracking function that determines whether the content is being used appropriately by the buyer.

Because the content brokering system handles the difficult negotiations and financial details of selling digital content, an ordinary consumer can more easily make his/her content available to others through the public submission content library of the present invention. Additionally, the search and content request functions provided by the content brokering system enable an individual to find content that is not available through most standard channels.

### DESCRIPTION OF THE DRAWINGS

FIG. 1A is a diagram illustrating an overview of the operation of an embodiment of a public submission content library according to the invention;

FIG. 1B is a diagram illustrating an overview of the operation of an alternate embodiment of the public submission content library;

FIGS. 2A and 2B are diagrams of a computer environment suitable for practicing the invention; and

FIGS. 3A-D are flow diagrams of a method to be performed by a computer according to an embodiment of the invention.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

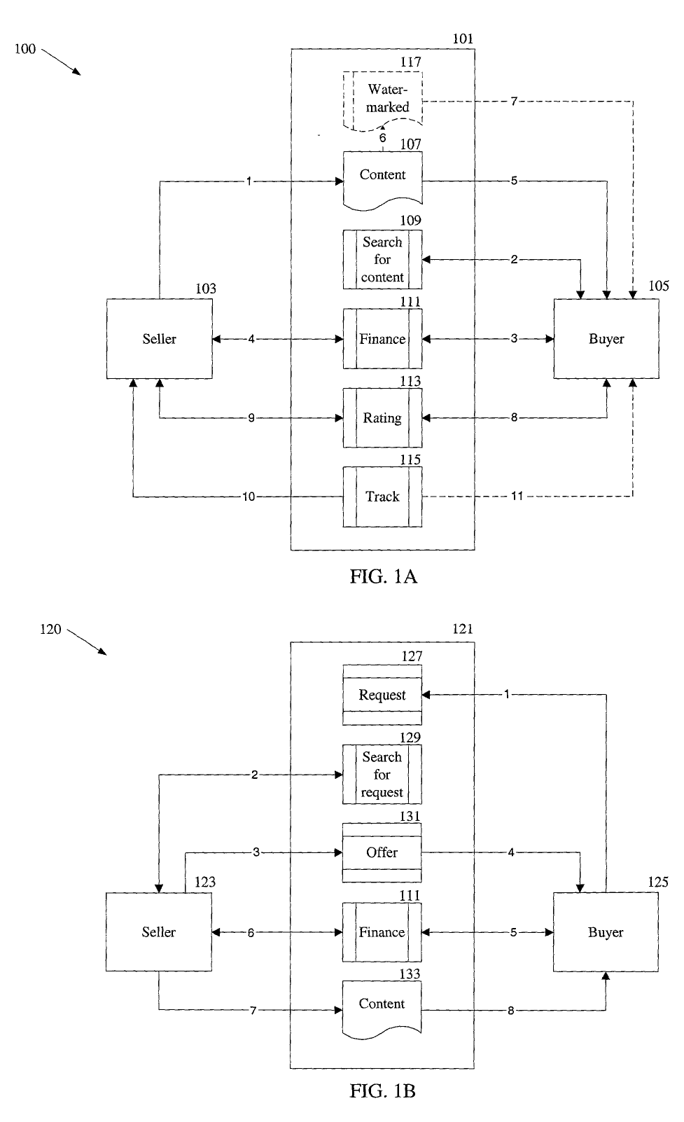

FIG. 1A illustrates an overview of the operation of one embodiment of a public submission content library 100 according to the invention. The library 100 comprises a content brokering system 101 that is used by a seller 103 and a buyer 105 to exchange content, such as images, video, music, text, games and applications. The seller 103 uploads content 107 to the content brokering system 101. Along with the content, other information may be uploaded, including but not limited to information about the content and sales/leasing prices. The content 107 and any related information is stored on the content brokering system 101 for viewing by potential buyers.

The buyer 105 uses a search function 109 provided by the content brokering system to search the content brokering system 101 for content meeting a set of user-defined criteria, such as type of content, date/time of creation, prices, etc. Assuming content 107 satisfies the criteria, the buyer 105 sends a bid for purchase of lease of the content 107 to a finance function 111 provided by the content brokering system 101. The finance function 111 forwards the bid onto the seller 103. The seller 103 can decide to accept the bid from the buyer, or may choose to submit a counteroffer to the finance function 111. The finance function 111 manages all the negotiation and financial dealings (tracking, handling, and authorizing) between the seller and the buyer. In one embodiment, the finance function 111 optionally offers suggestions to improve the negotiations. For example, the finance function 111 could ask the seller 103, “If the buyer would pay $X, would you sell?” and act on a positive response by submitting a counteroffer of $X to the buyer 105.

Assuming that a price is agreed upon, the finance function 111 receives and verifies the payment from the buyer 105. Once the finance function 111 determines that valid payment has been received, the content brokering system 102 releases the content to the buyer 105, completing the transaction between the buyer 105 and the seller 103. The finance function 111 also informs the seller 103 of the receipt of funds and the release of the content. In alternate embodiments, the buyer 105 and seller 103 may bypass some or all of the services provided by the finance function 111. In particular, the payment services of the finance function 111 are unnecessary if the seller is not charging for the use of the content. If the buyer 105 sends payment directly to the seller 103, the seller 103 must authorized the content brokering system 101 to release the content to the buyer 105.

The content brokering system 101 also provides watermarking services to the seller 103. Watermarking is a conventional technique that restricts the use of the content to specific applications or limits the further distribution of the content. If the seller 103 requests watermarking, the content brokering system 101 applies the appropriate watermark to the content 107 and releases the resulting watermarked content 117 to the buyer 105.

The content brokering system 101 also contains a rating function 113 that asks both parties to rate the other party and the content. The rating function 113 may ask for ratings when the transaction is successfully completed and also when the negotiations are terminated unsuccessfully. The ratings are available for review by potential buyers and sellers on the content brokering system 101.

The content brokering system 101 also offers a tracking function 115 to the seller 103. The tracking function 115 allows the seller 103 to determine whether the content is being used appropriately and, if there was a time limit on the use of the content, whether the content is being used beyond the time limit. The tracking function 115 will search servers connected to the Internet or other accessible networks for the content and, if found, determine if the content is being used appropriately. The tracking function 115 reports its findings to the seller 103. Optionally, the tracking function 115 can also inform the buyer 105 of erroneous content usage (shown in phantom).

FIG. 1B illustrates an alternate embodiment of a public submission content library 120 in which content 133 available for purchase or lease from a seller 123 is not permanently stored on a content brokering system 121. Instead the content brokering system 121 receives a request 127 for content having particular characteristics from a buyer 125. The characteristics may include type of content, date/time of creation, a sample of the desired content, purchase price, etc.

The seller 123 uses a search function 129 provided by the content brokering system 121 to determine if any requests have been posted to the content brokering system 121 that match the content 133. If the search finds a request that is satisfied by the content 133, the seller 123 sends an offer 131 to the content brokering system 121 addressed to the buyer 125 as a private message that is forwarded by the content brokering system 121. In an alternate embodiment, the offer 131 may be posted on a bulletin board maintained by the content brokering system 121. In yet another embodiment, the seller 123 may send the offer 131 directly to the buyer through standard e-mail or some mechanism external to the content brokering system 121. The offer 131 may contain a sample of the content 133 so the buyer 125 can determine if the content 133 is what is wanted. To prevent against unauthorized use of the sample in the offer 131, it may be of a lower resolution or quality, a type overlay or a distorted version that permits the buyer 105 a view of the content 133.

Assuming the buyer 125 does want to purchase or lease the content 133, the buyer 125 submits a bid to the finance function 111 and the transaction processing proceeds as described above. When agreement is reached between the parties, the content 133 is sent to the buyer 125 to complete the transaction. In one embodiment, the seller 123 uploads the content 133 to the content brokering system 121, which then releases the content 133 to the buyer 125 as in FIG. 1A. In an alternate embodiment, the seller 123 can send the content 133 directly to the buyer 125.

The content brokering system 121 can also supply a watermarked version of the content 133 to the buyer 125 using the watermarking services described above. The rating and tracking functions previously described for the content brokering system 101 may also be provided by the content brokering system 121.

The content brokering system 101, 121 may obtain compensation from either the seller 103, the buyer 105, or both, for providing the brokering services described above. Such compensation may be a flat amount per piece of content, a sliding scale based on amount of content sold or purchased with a given period of time, a percentage of the agreed price of the content, , or be calculated using other types of fee structures. In addition, the content brokering system 101, 121 may receive revenue from advertisements displayed to buyers and sellers.

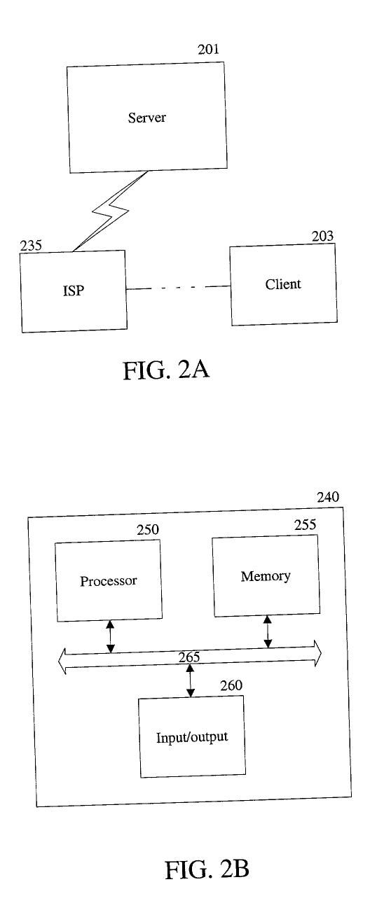

In one embodiment, as shown in FIG. 2A, a server computer 201 acts as the content brokering system 101, 121 and is part of, or coupled to, an ISP (Internet Service Provider) 235 to provide content over the Internet to buyers and seller of content. A client computer 203 acting as either seller 103 or buyer 105 executes a conventional Internet browsing application to exchange data with the server 201. It is readily apparent that the present invention is not limited to Internet access and Internet web-based sites; directly coupled and private networks are also contemplated.

One embodiment of a computer system suitable for use as content brokering system server 101, 121 is illustrated in FIG. 2B. The computer system 240, includes a processing unit (processor) 250, memory 255 and input/output capability 260 coupled to a system bus 265. The memory 255 is configured to store instructions which, when executed by the processor 250, perform the methods described herein. The memory 255 may also store content uploaded to the content brokering system by the seller. Input/output 260 provides for the delivery and display of the content to the buyer or portions or representations thereof. Input/output 260 also encompasses various types of computer-readable media, including any type of storage device that is accessible by the processor 250,. One of skill in the art will immediately recognize that the term “computer-readable medium/media” further encompasses a carrier wave that encodes a data signal. It will also be appreciated that the server 201 is controlled by operating system software executing in memory 255. Input/output and related media 260 store the computer-executable instructions for the operating system and methods of the present invention as well as the uploaded content.

The description of FIGS. 2A-B is intended to provide an overview of computer hardware and other operating components suitable for implementing the invention, but is not intended to limit the applicable environments. It will be appreciated that the computer system 240 is one example of many possible computer systems which have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

Thus, the public submission content library of the present invention facilitates the exchange digital content between a buyer and a seller. While the invention is not limited to any particular arrangement and types of content brokering services, for sake of clarity a simplified content brokering system has been described that provides content storing, searhing, financing, watermarking, rating, and tracking functions to its users. It will be appreciated that the division of the content brokering services into the functions described above are for ease in description and are not limiting.

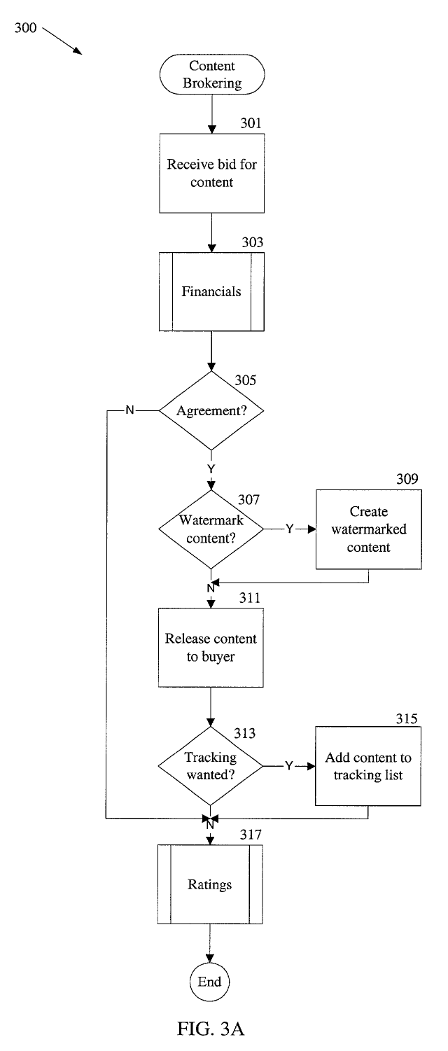

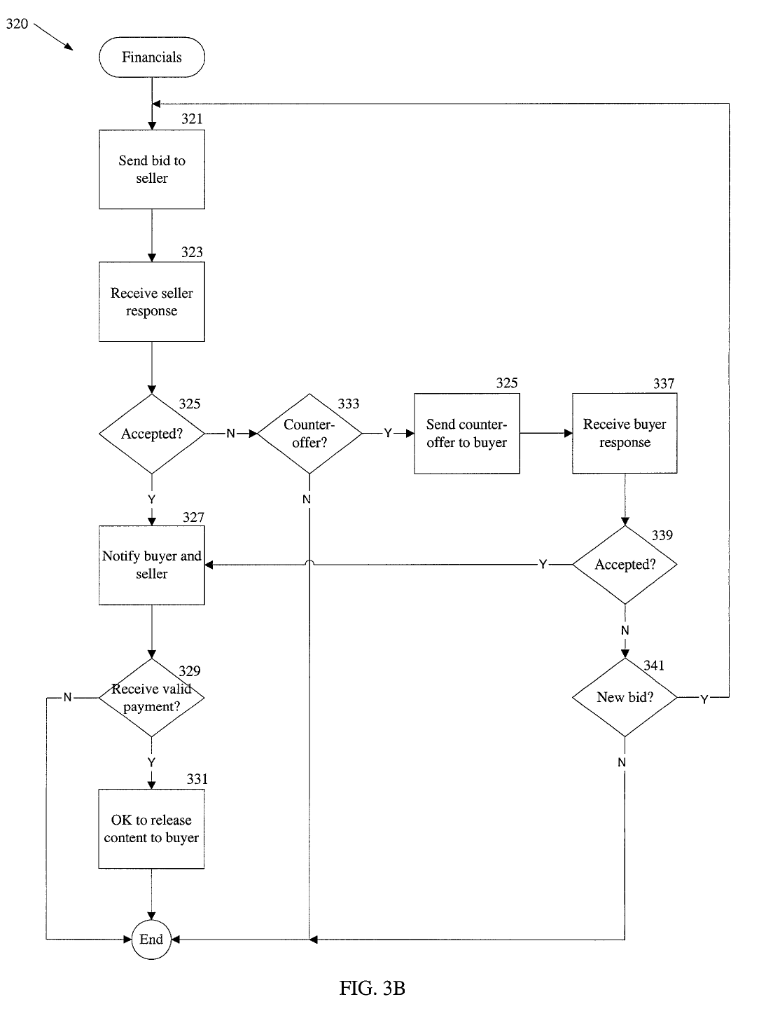

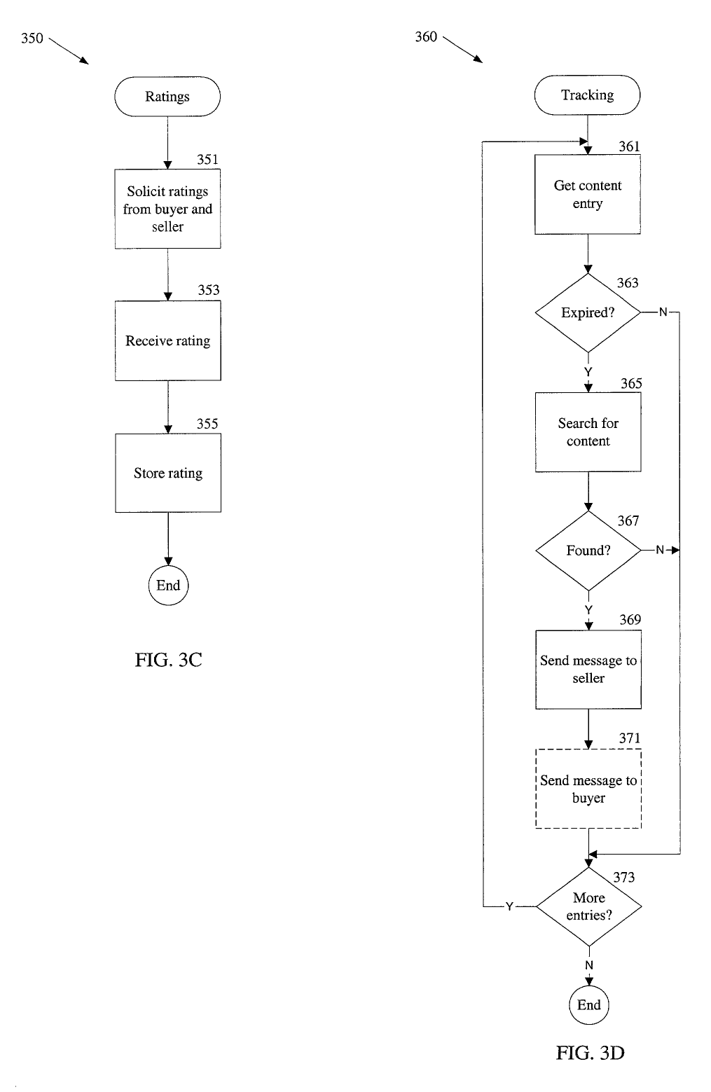

Next, the particular methods of the invention are described in terms of computer software with reference to a series of flow diagrams. A content brokering method illustrated in FIG. 3A executes in a server computer acting as content brokering system 101 or 121. Supporting methods for the content brokering method are illustrated in FIGS. 3B-D. The methods constitute computer programs made up of computer-executable instructions illustrated as blocks (acts) 301 until 317 in FIG. 3A, blocks 321 until 341 in FIG. 3B, blocks 351 until 355 in FIG. 3C, and blocks 361 until 373 in FIG. 3D. Describing the methods by reference to a flow diagram enables one skilled in the art to develop such programs including such instructions to carry out the methods on suitably configured computers (the processor of the computer executing the instructions from computer-readable media). If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result. It will be appreciated that more or fewer processes may be incorporated into the methods illustrated in FIGS. 3A-D without departing from the scope of the invention and that no particular order is implied by the arrangement of blocks shown and described herein.

Referring first to FIG. 3A, the acts to be performed by a computer executing the content brokering method 300 are shown. When a bid is received for content from a buyer (block 301), the content brokering method 300 invokes a financials method (block 303) to manage the negotiations and handle the financial arrangements between the buyer and the seller. One embodiment of the financials method is described further below in conjunction with FIG. 3B. If an agreement is reached between the parties (block 305), the content brokering method determines whether the seller wants the content to be watermarked (block 307). If watermarking is desired, the content brokering system creates the appropriate watermarked content (block 309). The appropriate version of the content is released to the buyer (block 311).

The content brokering method 300 also determines whether tracking is desired by the seller (block 313). If it is, the method 300 adds an identifier for the content to a tracking list (block 315). The tracking function is described further below in conjunction with FIG. 3D. Whether the parties have come to agreement or not, the content brokering system 300 solicits ratings from the parties (block 317) as further described in conjunction with FIG. 3C below

Turning now to FIG. 3B, one embodiment of a financials method 320 is described that is invoked by the content brokering method 300 at block 303 as a result of receiving a bid for content from a buyer. The bid is sent to the seller of the content (block 321) for consideration. When the seller's response is received at block 323, the financials method 320 determines if the seller has accepted the bid (block 325). If so, the financials method 320 notifies both the buyer and the seller that agreement has been reached (block 327). The financials method 320 waits to receive payment from the buyer (block 329). Assuming payment is received within a predetermined period of time, the financials method 320 signals the content brokering content method 300 to release the content to the buyer (block 331). Otherwise, if payment is not received within the predetermined period of time, or if the payment is not good, the financials method 320 ends and the content is not released.

Returning now to block 325 and assuming that the initial bid is not accepted, the seller may have made a counteroffer (block 333). If no counteroffer is made, the negotiations are terminated and the financials method 320 ends without agreement between the parties. If a counteroffer is made, it is sent to the buyer at block 335 for consideration. When the buyer's response is received at block 337, the financials method 320 determines if the buyer accepted the counteroffer (block 339). If so, the financials method continues processing with block 327 and proceeds as previously described. If the counteroffer is not accepted, the buyer may have made a new bid (block 341) and, if so, the financials method 320 returns to block 321 where it sends the new bid to the seller and continues through the processing as described previously for the initial bid. Otherwise, if there is no new bid, the negotiations are terminated and the financials method 320 ends.

An embodiment of a rating method 350 is described in conjunction with FIG. 3C that is invoked by the content brokering method 300 at block 317 in FIG. 3A. The ratings method solicits ratings from both the buyer and the seller (block 351), receives a rating from either of the buyer or the seller or both (block 353) and stores those ratings on the content brokering system (block 355) where they can be viewed by other potential buyers and sellers.

A tracking method 360 illustrated in FIG. 3D is performed periodically by the content brokering system to track content as requested by the sellers of the content. In the embodiment shown in FIG. 3D, the tracking method 360 searches for content that is being used after the expiration date of its lease. It will be appreciated that content having other use limitations also can be tracked by the tracking method 360. In the present embodiment, the tracking list has an entry for each piece of content to be tracked, with each entry containing a content identifier specific to the content and the buyer. The content identifier may be in the form of a watermark. When the content is leased, the entry may also have the expiration date of the lease, or the expiration data may be part of the content identifier.

The tracking method 360 gets a content entry from its tracking list (block 361) and determines whether the lease for the content entry has expired (block 363). If it has not, the tracking method 360 determines if there are more entries in the list (block 373) and examines the next entry in the list at block 361 if there are. For each piece of content with an expired lease, the tracking method 360 searches servers connected to accessible networks, such as the Internet, for the content (block 365). If the content is found (block 367), a message is sent to the seller (block 369). Optionally, at block 371, a message may also be sent to the buyer. When all entries in the tracking list have been examined, the tracking method 360 ends.

While the methods illustrated in FIGS. 3A-D are described as a continuous logical flow, one of skill in the art will readily appreciate that the processes represented by the blocks do not have to execute contiguously in time and that the methods may pause and resume as necessary to carry out the functions described.

A content brokering system for a public submission content library that facilitates the exchange digital content between a buyer and a seller has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application with respect to communications between clients and servers is meant to include all networked environments, public and private, local and wide area. Therefore, it is manifestly intended that this invention be limited only by the following claims and equivalents thereof.

What is claimed is:

1. A computerized method for brokering digital content between a buyer and a seller on a public submission content library comprising:
performing a search for content using user-specified criteria;
receiving a bid from the buyer for content found by the search;
sending the bid to the seller;
receiving a response to the bid from the seller; and
releasing the content to the buyer if agreement is reached between the buyer and the seller.

2. The computerized method of claim 1, wherein the search searches for a request from the buyer for content having the user-specified criteria.

3. The computerized method of claim 2 further comprising:
receiving an offer from the seller of the content in response to the search for a request; and
sending the offer to the buyer.

4. The computerized method of claim 3, wherein the offer comprises a sample of the content.

5. The computerized method of claim 2, wherein releasing the content to the buyer comprises:
receiving the content from the seller; and
sending the content to the buyer.

6. The computerized method of claim 1 further comprising receiving the content from the seller prior to the search.

7. The computerized method of claim 1, wherein the response from the seller is a counteroffer and further comprising:
sending the counteroffer to the buyer; and
receiving a response to the counteroffer from the buyer.

8. The computerized method of claim 1 further comprising:
receiving payment for the content from the buyer; and
validating the payment.

9. The computerized method of claim 1, wherein releasing the content to the buyer comprises:
watermarking the content; and
sending the content as watermarked to the buyer.

10. The computerized method of claim 1 further comprising soliciting a rating from the buyer and the seller.

11. The computerized method of claim 1 further comprising:
tracking use of the content by the buyer in accordance with restrictions placed on the content by the seller; and
notifying the seller if the use of the content by the buyer violates the restrictions.

12. The computerized method of claim 11 further comprising:
notifying the buyer if the use of the content by the buyer violates the restrictions.

13. The computerized method of claim 1 further comprising:
receiving compensation for brokering services from the buyer.

14. The computerized method of claim 1 further comprising:
receiving compensation for brokering services from the seller.

15. The computerized method of claim 1 further comprising:
receiving revenue for advertisements displayed to the buyer and seller.

16. A computerized server comprising:
a processing unit;
a memory coupled to the processing unit through a system bus; and
a search function executed from the memory to cause the processing unit to perform a search for content having user-defined criteria; and
a financials function executed from the memory to cause the processing unit to manage negotiations between a buyer and a seller of content found by the search function.

17. The computerized server of claim 16, wherein the financials function further operates to cause the processing unit to manage a payment from the buyer to the seller.

18. The computerized server of claim 16, wherein the search function operates to cause the processing unit to search for a request from the buyer for content having the user-specified criteria.

19. The computerized server of claim 16 further comprising:
a watermarking function executed from the memory to cause the processing unit to watermark the content.

20. The computerized server of claim 16 further comprising:
a ratings function executed from the memory to cause the processing unit to solicit a rating from the buyer and the seller.

21. The computerized server of claim 16 further comprising:
a tracking function executed from the memory to cause the processing unit to track use of the content by the buyer in accordance with restrictions placed on the content by the seller and further to notify the seller if the use of the content by the buyer violates the restrictions.

22. A computer-readable medium having computer-executable instructions comprising:
a search function to perform a search for content having user-defined criteria; and
a financials function to manage negotiations between a buyer and a seller of content found by the search function.

23. The computer-readable medium of claim 22 having further computer-executable instructions to cause the financials function to manage a payment from the buyer to the seller.

24. The computer-readable medium of claim 22 having further computer-executable instructions to cause the search function to search for a request from the buyer for content having the user-specified criteria.

25. The computer-readable medium of claim 22 having further computer-executable instructions comprising:
a watermarking function to watermark the content.

26. The computer-readable medium of claim 22 having further computer-executable instructions comprising:
a ratings function to solicit a rating from the buyer and the seller.

27. The computer-readable medium of claim 22 having further computer-executable instructions comprising:
a tracking function to track use of the content by the buyer in accordance with restrictions placed on the content by the seller and to notify the seller if the use of the content by the buyer violates the restrictions.
